(19) United States
(12) Patent Application Publication
(10) Pub. No.: US 2020/0137126 A1
(43) Pub. Date: Apr. 30, 2020

(54) CREATION OF SECURITY PROFILES FOR WEB APPLICATION COMPONENTS

(71) Applicant: Tala Security, Inc., Fremont, CA (US)

(72) Inventors: Siddhesh Yawalkar, San Jose, CA (US); Swapnil Bhalode, San Jose, CA (US); Brian Blair, Berkeley, CA (US); Jason Yang, Saratoga, CA (US); Vaibhav Rastogi, Madison, WI (US)

(21) Appl. No.: 16/669,201

(22) Filed: Oct. 30, 2019

Related U.S. Application Data
(60) Provisional application No. 62/753,766, filed on Oct. 31, 2018.

(51) Int. Cl. H04L 29/06

(52) U.S. Cl. CPC H04L 63/205; H04L 63/1433

(57) ABSTRACT

Techniques to facilitate creation of security profiles for web application components are disclosed herein. In at least one implementation, a plurality of web resources used to construct web applications is received. The plurality of web resources is analyzed to generate normalized fingerprints for each of the web resources. A plurality of security risk factors is determined for each of the plurality of web resources based on the normalized fingerprints generated for each of the web resources. A reputation score is generated for each of the plurality of web resources based on the security risk factors determined for each of the web resources.

### RELATED APPLICATIONS

This application claims the benefit of, and priority to, U.S. Provisional Patent Application No. 62/753,766, entitled “Method for Building the Security Profile of Web Application Components”, filed on Oct. 31, 2018, which is hereby incorporated by reference in its entirety for all purposes.

### TECHNICAL BACKGROUND

Application-layer attacks are a major vulnerability of the security industry and are one of the largest sources of data breaches. Application-layer attacks exploit vulnerabilities within an application as well as insecure components and insecure coding practices used in building the application. Existing methodologies to protect an application rely on analysis techniques to identify already-published or known bugs and vulnerabilities, and then either requiring the application software developers to fix those bugs and remove the vulnerabilities in the application code, or generating virtual patches that can be configured on network firewalls and intrusion prevention systems to prevent the exploitation of those vulnerabilities. However, this blacklist approach, which attempts to prevent known malicious users, code, or inputs from reaching the application, offers inadequate protection because it only protects against attack vectors and vulnerabilities that have been previously discovered.

Modern web applications integrate code and resources from dozens of third-party service providers, including content delivery networks (CDNs) and third-party JavaScript libraries, and may range in function from user analytics to marketing tags, among other examples. Recent studies have found that almost two thirds of the content and code at websites is loaded from third parties. A significant portion of this content comprises executable scripts with direct security impact on a website. A greater security risk is due to the way in which many advertising platforms are set up, where the advertising host sites may not even be aware of which servers are placing content on the website. In the absence of proper vetting for third-party executable content, this content may be compromised or malicious. Many recent examples of crypto-jacking attacks have transpired involving a third-party library serving crypto-mining code to users from thousands of websites. In addition, recent breaches of user data on many popular websites have been attributed to compromised third-party chat clients.

### TECHNICAL BACKGROUND

Techniques to facilitate creation of security profiles for web application components are disclosed herein. In at least one implementation, a plurality of web resources used to construct web applications is received. The plurality of web resources is analyzed to generate normalized fingerprints for each of the web resources. A plurality of security risk factors is determined for each of the plurality of web resources based on the normalized fingerprints generated for each of the web resources. A reputation score is generated for each of the plurality of web resources based on the security risk factors determined for each of the web resources.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates a communication system.

FIG. 2 is a flow diagram that illustrates an operation of the communication system.

FIG. 3 is a block diagram that illustrates an example abstract syntax tree generated for a web resource in an exemplary embodiment.

FIG. 4 is a block diagram that illustrates an example abstract syntax tree generated for a web resource in an exemplary embodiment.

FIG. 5 is a block diagram that illustrates an example abstract syntax tree generated for a web resource in an exemplary embodiment.

FIG. 6 is a flow diagram that illustrates an operation of a communication system in an exemplary embodiment.

FIG. 7 is a flow diagram that illustrates an operation of a communication system in an exemplary embodiment.

FIG. 8 is a block diagram that illustrates a computing system.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Existing methods of screening for use of current and old versions of packages use manually-created blacklists. However, such methods do not provide fine-grained problematic behaviors, constructs, or snippets of code. Analyzing third-party web components requires tremendous expertise in static code analysis, dynamic runtime instrumentation, and correlating known vulnerabilities, personally identifiable information (PII) data collection, dangerous JavaScript constructs, and other exploits. In short, this process is too costly and time consuming, significantly slowing down the modern DevOps methodology, geared towards addressing daily or weekly changes to a web application. Further, the sheer number of locations from where code and content is loaded can be very large. As an example, when a user loads the homepage of a popular, top-ranking website, the user's web browser could be receiving code and content from as many as fifty different sites.

The techniques disclosed herein provide a security solution to automatically build security profiles of popular, widely-available web application components provided by third parties, such as libraries, fonts, style sheets, scripts, and other web resources used in construction of a modern website. In at least one implementation, these security characteristics may be stored in a large, scalable repository called Metabase. Metabase may be created and automatically populated with the security characteristics of millions of popular third-party web components used in building a modern web application. The Metabase repository also has the ability to absorb incremental changes over time through continuous updates with security characteristics of new objects and newly discovered security attributes of millions of existing objects, which enables Metabase to provide zero-day vulnerability protection by preemptively detecting malicious exploits of web application components. Beneficially, Metabase provides a single source of truth about the security attributes of various building blocks utilized extensively at top ranking websites. For example, a web application may be evaluated by referring to Metabase and proactively warning developers and security personnel about the risks associated with using certain third-party components. Metabase may also be queried through application programming interface (API) calls to retrieve the security attributes and reputation scores for desired web objects identified by one or more fingerprinting algorithms, such as abstract syntax trees. Additionally, hosts of third-party component repositories (such as CDNs) can benefit from Metabase by ensuring that their repository contents meet certain security criteria.

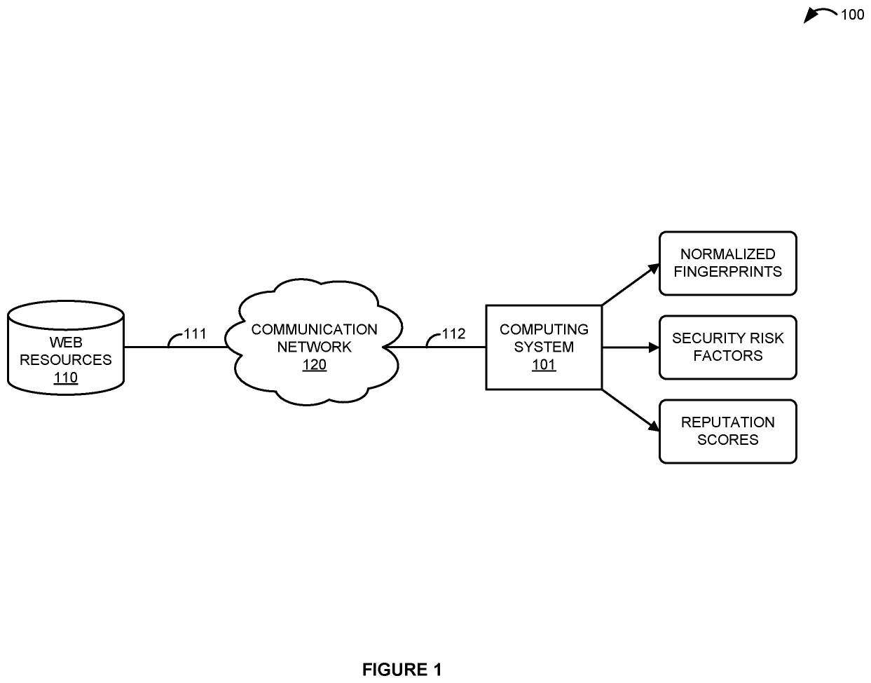

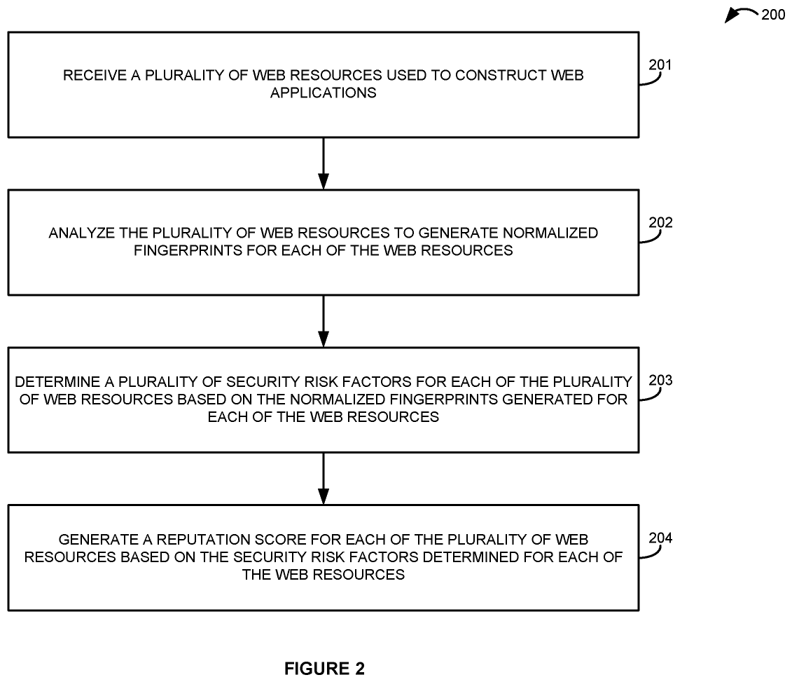

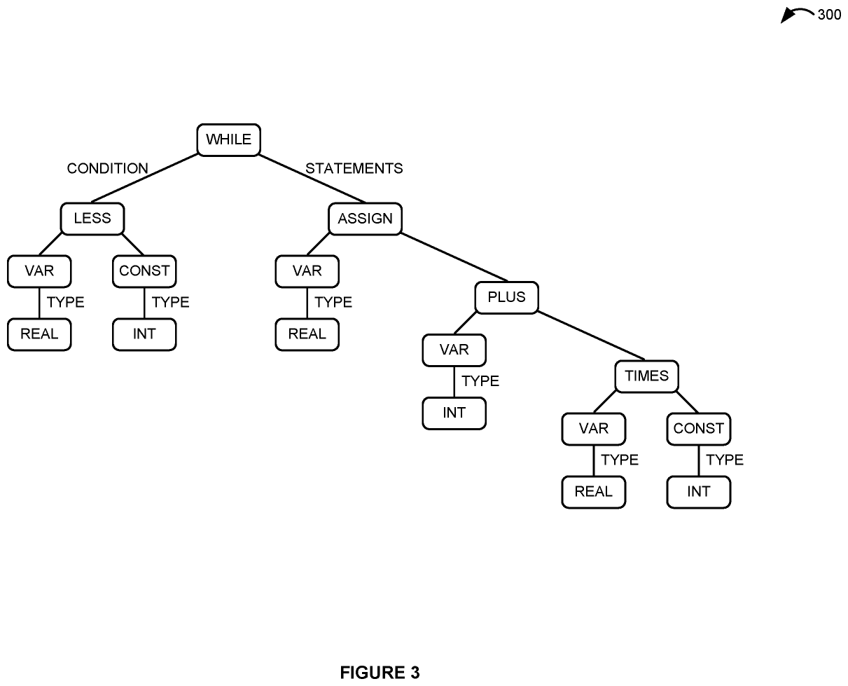

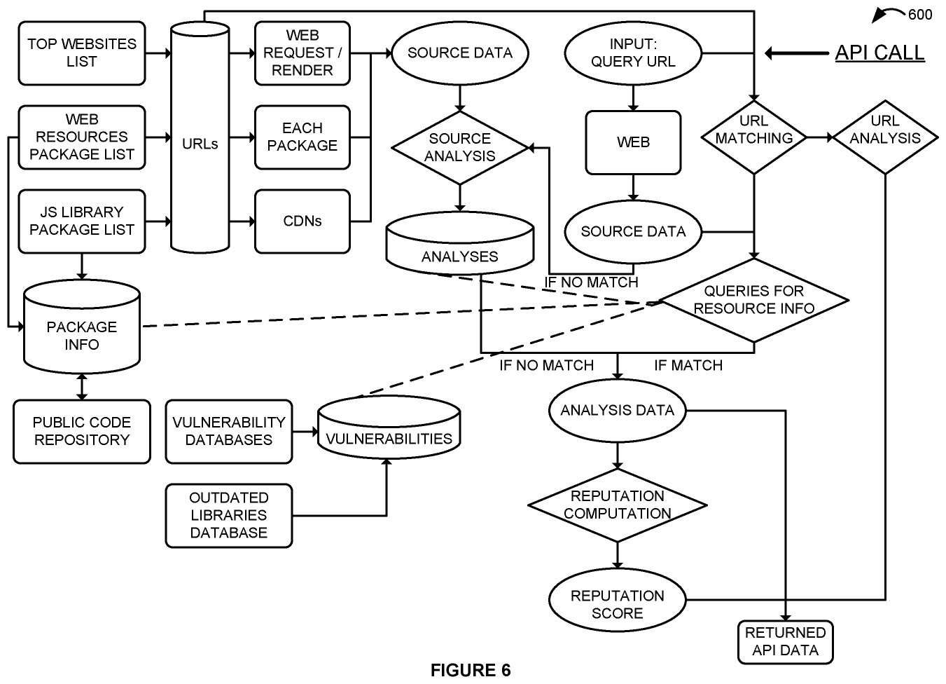

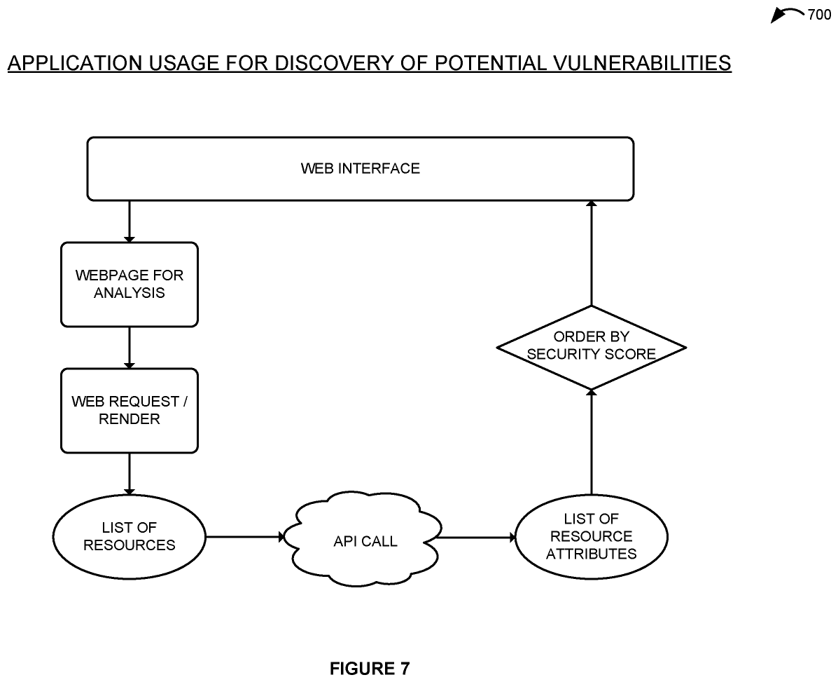

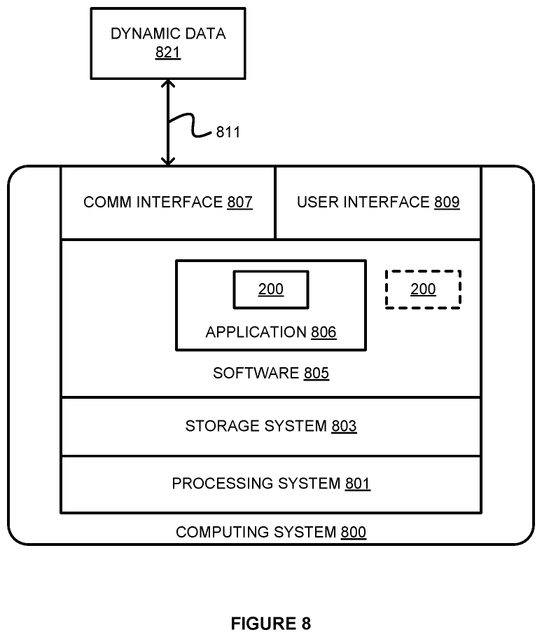

Referring now to the drawings, FIG. 1 illustrates a communication system that may be used to build security profiles for web application components. FIG. 2 is a flow diagram that illustrates a security profile creation process that may be performed by the communication system. FIG. 3 through 5 illustrate various example abstract syntax trees that may be generated for web resources in exemplary embodiments. FIG. 6 is a flow diagram that illustrates an operation of a communication system to perform data collection, analysis, and reputation scoring of web resources, along with API call handling to process a uniform resource locator (URL) query in an exemplary embodiment. FIG. 7 is a flow diagram that illustrates application usage for discovery of potential vulnerabilities in an exemplary embodiment. Finally, FIG. 8 illustrates an exemplary computing system that may be used to perform any of the security profile creation processes and operational scenarios described herein.

Turning now to FIG. 1, a block diagram of communication system 100 is illustrated. Communication system 100 includes web resources 110, communication network 120, and computing system 101. Web resources 110 and communication network 120 communicate over communication link 111, while computing system 101 and communication network 120 communicate over communication link 112. In at least one implementation, computing system 101 could comprise a system that provides a cloud-based web service.

In operation, computing system 101 executes an advanced resource analysis and threat analytics service to assess a plurality of web resources 110 to facilitate creation of security profiles for these web application components. In at least one implementation, computing system 101 receives over communication network 120 a plurality of web resources 110 used to construct web applications, and generates normalized fingerprints for each of the web resources 110, determines a plurality of security risk factors for each of the web resources 110, and generates reputation scores for each of the web resources 110. Beneficially, the techniques described herein provide a methodology to efficiently obtain security characteristics and a general security score for arbitrary web resources such as JavaScript files, libraries, fonts, style sheets, and any other web application components. These techniques enable computing system 101 to scalably analyze popular third-party components using a combination of metadata analysis, static and dynamic runtime analysis, determination of processing sensitive information, and correlation with publicly available vulnerability databases to determine the risk posed by using these objects in constructing a web application. For example, to build an exhaustive information model for each of the web resources 110, several application analysis techniques may be combined, such as static analysis of source code and/or binary images of the web resources 110, dynamic analysis of a running instance of the web objects 110 in an instrumented environment, dynamic analysis by remotely exercising the web objects 110, metadata analysis, dependency analysis between components, libraries, frameworks, runtime parameters, and service discovery, among other analysis techniques. The combination of analysis techniques may be used to calculate a confidence level about the accuracy and completeness on a per-attribute or per-attribute class basis for each of the web resources 110, which may also be used in determining the security risk factors for each of the web resources 110 in some examples. In at least one implementation, when determining the security risk factors for each of the web resources 110, computing system 101 may utilize the prevalence or absence of the web resources 110 in the top ranking websites as a risk factor.

Once the security risk factors and the reputation score for each of the web resources 110 are generated, computing system 101 may utilize the automatically derived security risk to inform developers and security personnel before deployment of a web application that incorporates some or all of the web resources 110. The system also has the ability to absorb incremental changes over time, such as the availability of a new version of a library or an entirely brand new library. The security risk factors and reputation scores generated for each of the web resources 110 may also allow authors of common libraries and other web application components to understand their work's security posture and areas for improvement. An exemplary implementation for analyzing a plurality of web resources 110 and generating a reputation score for each of the web resources 110 will now be discussed with respect to FIG. 2.

FIG. 2 is a flow diagram that illustrates an operation 200 of communication system 100. The operation 200 shown in FIG. 2 may also be referred to as security profile creation process 200 herein. The steps of the operation are indicated below parenthetically. The following discussion of operation 200 will proceed with reference to computing system 101 and web resources 110 of FIG. 1 in order to illustrate its operations, but note that the details provided in FIG. 1 are merely exemplary and not intended to limit the scope of process 200 to the specific implementation shown in FIG. 1.

Operation 200 may be employed by computing system 101 to facilitate creation of security profiles for web application components. As shown in the operational flow of FIG. 2, computing system 101 receives a plurality of web resources 110 used to construct web applications (201). In some examples, the web resources 110 could comprise building blocks for constructing web applications, which may be requested by a client to load a webpage. For example, web resources 110 may include third-party libraries, fonts, style sheets, plugins, tag managers, scripts, or any other web objects. The plurality of web resources 110 may be received by computing system 101 from any source. For example, in at least one implementation, computing system 101 could be configured to crawl and download web resources 110 from open-source web object repositories, such as CDNJS, npm, unpkg, jsDelivr, and other popular repositories. During this data collection or data discovery phase, computing system 101 may utilize standard web crawling and scraping techniques to fetch and download all potential web objects, scripts, fonts, style sheets, JavaScript libraries, advertising content, and other web resources 110 from an exhaustive list of CDNs and other data sources. In at least one implementation, the web resources 110 are received by computing system 101 incrementally over time, so that if a new resource is added or an existing resource is updated, the web resources 110 available to computing system 101 are updated as well.

Computing system 101 analyzes the plurality of web resources 110 to generate normalized fingerprints for each of the web resources 110 (202). In order to generate the normalized fingerprints, in some implementations, each of the web resources 110 are processed by computing system 101 to perform various techniques for extracting security attributes of the web objects, such as object fingerprinting algorithms, abstract syntax trees, hash functions, and other data categorization and parsing techniques. The normalized fingerprints generated for each of the web resources 110 may describe the security attributes of each of the web resources 110 in some examples. In at least one implementation, the normalized fingerprints generated for each of the web resources comprise abstract syntax trees. In some implementations, computing system 101 analyzes the plurality of web resources 110 to generate the normalized fingerprints for each of the web resources by analyzing syntactic structures of the plurality of web resources 110 to generate the normalized fingerprints for each of the web resources 110. For example, the syntactic structure of the web resources 110 may be used to create the normalized fingerprints, or abstract syntax trees, for each of the web resources 110. In other words, the normalized fingerprints may be based on the syntactic structure of the web resources 110. For example, the normalized fingerprints for each of the web resources 110 may be normalized with respect to the structure of the web resources 110, in that the normalized fingerprints may be derived from and representative of the syntactic structure of the web resources 110 and the data types of values on the leaf nodes of abstract syntax trees.

Computing system 101 determines a plurality of security risk factors for each of the plurality of web resources 110 based on the normalized fingerprints generated for each of the web resources 110 (203). In at least one implementation, to determine the security risk factors for each of the web resources 110, computing system 101 may analyze security attributes identified by the normalized fingerprints generated for each of the web resources 110. In some implementations, to determine the plurality of security risk factors for each of the web resources 110, computing system 101 may utilize a combination of multiple analysis techniques to extract security-relevant attributes from the normalized fingerprints generated for each of the web resources 110, such as static analysis, dynamic analysis, machine learning, metadata analysis, and domain-specific heuristics. For example, computing system 101 could analyze each of the web resources 110 offline with an automated static analysis and metadata analysis, which may be supplemented with dynamic runtime analysis of the security attributes identified by the normalized fingerprints generated for each of the web resources 110. Computing system 101 may also analyze and compare each of the web resources 110 against popular vulnerability databases, such as national vulnerability database (NVD), open source security platforms, and other vulnerability tracking resources to determine if there are known disclosures of vulnerabilities by vendors against any of the web resources 110. In addition, computing system 101 may analyze each of the web resources 110 using tools that identify outdated libraries, such as RetireJS, among others, and may further refer to data loss prevention (DLP) dictionaries to determine if any sensitive data is manipulated. In at least one implementation, computing system 101 may determine the security risk factors for each of the web resources 110 by determining the security risk factors for each of the web resources 110 based on prevalence of each of the web resources 110. For example, computing system 101 may determine the prevalence for each of the security attributes identified by the normalized fingerprints generated for the web resources 110 by identifying how frequently each of these attributes are utilized by a majority of top ranking websites. The idea of prevalence reduces the security risk factor, so if a particular web resource 110 and/or security attribute is used by a majority of top sites and is highly prevalent, then that reduces the security risk, since so many sites are using it safely. On the contrary, if a particular script, library, or some other web resource 110 is not used by any prominent websites, then the resource or feature is more unknown and could be malicious, so the security risk factor is higher. Some examples of the security risk factors for each of the web resources 110 include prevalence in the top one million websites, comparison against the NVD, common vulnerabilities and exposures (CVEs), and other open source security platforms, occurrence and frequency of security incidents, outdated libraries, such as the number of major and/or minor updates or revisions behind a current version, relative age, reputation of the publisher, similarity with adblocker scripts, similarity with privacy snooping scripts, presence of dangerous JavaScript constructs such as eval, instances of personally identifiable information (PII) handling, obfuscation measures, such as an assessment of effectiveness of code or PII obfuscation techniques, and any other security risk factors. Note that the above security risk factors are merely exemplary, and many other security risk factors are possible and within the scope of this disclosure.

Computing system 101 generates a reputation score for each of the plurality of web resources 110 based on the security risk factors determined for each of the web resources 110 (204). In some implementations, computing system 101 may compute a reputation score to each of the web resources 110 based on the security risk factors across a diverse set of security attributes. In at least one implementation, the reputation score could comprise a numerical metric that summarizes the security safety score, such as within a range of zero to one hundred, of a web resource considering the relative weights of the security risk factors, various security attributes, and other features associated with the web resource. For example, computing system 101 could generate a reputation score based on weighted scoring, with the weights assigned based on the relative risk of the security risk factors determined for each of the features of one of the web resources 110. Additionally or alternatively, in at least one implementation, computing system 101 could generate the reputation score for each of the web resources 110 based on the security risk factors by generating the reputation score for each of the web resources 110 based on levels of information gain associated with each of the web resources 110. In some implementations, information gain could be determined by establishing some kind of ground truth and correlating that known truth to each of the features of a particular web resource. For example, different levels of information gain may be determined for particular attributes or features of a web resource when there are one or more known vulnerabilities of the resource. The analysis could then include determining which of the features or attributes of the web resource correlate very highly to the known vulnerability of the resource, so that those features would be given higher relative weights because they provide the most information gain. For example, there may be twenty different features or attributes of a web resource, but the one feature with the highest correlation to the known vulnerability of the resource may be given a weight of fifty percent, based on an analysis and determination of that one feature being responsible for most of the vulnerability of the entire web resource.

In another example, a database may contain one thousand scripts that are known to be malicious, and the techniques disclosed herein could be performed on these scripts to evaluate them and identify all of their security features using fingerprinting techniques and abstract syntax trees. Computing system 101 could then determine, for each of the features identified, which of the features are overlapping and the most prominent across all one thousand malicious scripts, which would provide the most information gain among all the scripts and would be weighted heavily relative to other features. In this example, assume that out of the one thousand malicious scripts, five hundred of them included this suspect attribute, so it may be weighted five hundred out of one thousand, or fifty percent. If another feature was only found in twenty of the scripts, that feature may be weighted relatively lower at twenty out of one thousand, or two percent. In this manner, computing system 101 can perform this analysis to determine the information gain of various features, attributes, and security risk factors of web resources 110, and then utilize this information to generate the weighted scoring for the reputation scores.

In some implementations, the normalized fingerprints, security risk factors, and reputation scores for each of the web resources 110 could be stored in a database, which may be called a metabase in some examples. In at least one implementation, the metabase could include an application programming interface (API) that may be utilized to query the metabase for security attributes for a web object identified by one or more fingerprinting algorithms, such as an abstract syntax tree hash. In such cases, computing system 101 may receive an API call that identifies a web object of a web application. Computing system 101 could then compare the web object to the normalized fingerprints for each of the web resources 110 to determine one of the web resources 110 that matches the web object, and return the reputation score for the one of the web resources 110 that matches the web object in response to the API call. In at least one implementation, in order to compare the web object to the normalized fingerprints for each of the web resources 110 to determine one of the web resources 110 that matches the web object, computing system 101 would first analyze the web object to generate a normalized fingerprint of the web object, and then compare the fingerprint of the web object to the fingerprints for each of the web resources 110 to determine a match. In addition, the normalized fingerprints may be used by computing system 101 to identify nearly identical web objects by ignoring simple syntactical changes like differences in spaces, tabs, commas, simple replacement of values such as changing the values of variables and constants, and the like. Another consideration when comparing the fingerprints of web objects and similar web resources 110 is the data types of variables and constants, such as integer, Boolean, real, long, float, string, and the like. For example, if the types are the same, the normalized fingerprints will match, but if the types of constants and variables on the leaf nodes of the abstract syntax trees change from an integer to a real or a string, then those variations will be noticed. In some implementations, the normalized fingerprints generated for each of the web resources 110 and web objects of a web application could comprise fuzzy fingerprints, which allow for a higher tolerance of differences between mostly similar web objects and web resources 110. For example, in fuzzy fingerprinting there is some tolerance for minor variations at the leaf nodes of the lower branches of abstract syntax trees, such as a replacement of an integer for a real number, tolerating further variations such as string constants changed to string variables, changes over time in some data points or constant values, and other small variations. The degree of acceptable tolerance for minor differences when comparing fuzzy and/or normalized fingerprints could be altered based on the security needs of individual users.

Advantageously, the techniques disclosed herein provide for efficiently determining security characteristics, risk factors, and security reputation scores for web resources 110 that are used in construction of web applications, such as libraries, fonts, style sheets, JavaScript files, and other web objects. Computing system 101 may operate to scalably analyze millions of popular third-party web components using a combination of static analysis, metadata analysis, dynamic runtime analysis, determination of processing sensitive information, and correlation with publicly available vulnerability databases to determine the security risk posed by using these objects in constructing web applications. In some situations, the automatically-derived security risk may be used to inform developers and security personnel before deployment of a web application that incorporates some or all of the web resources 110. Further, in at least one implementation, a scalable repository called metabase may be created and automatically populated with the security characteristics of millions of popular third-party web components used in building a modern web application. The metabase repository has the ability to absorb incremental changes over time through continuous updates with security characteristics of new objects and newly discovered security attributes of millions of existing objects. In this manner, the metabase repository provides the definitive, universal standard and go-to source for validating web application components, providing a single source of truth about the security attributes of various building blocks utilized extensively at top ranking websites, which may be queried through API calls to retrieve the security attributes and reputation scores for any desired web objects. Further, by preemptively detecting malicious exploits and other anomalies in web application components, the metabase repository may be utilized to provide zero-day vulnerability protection for modern web applications. An exemplary representation of a web resource expressed in an abstract syntax tree will now be discussed with respect to FIG. 3.

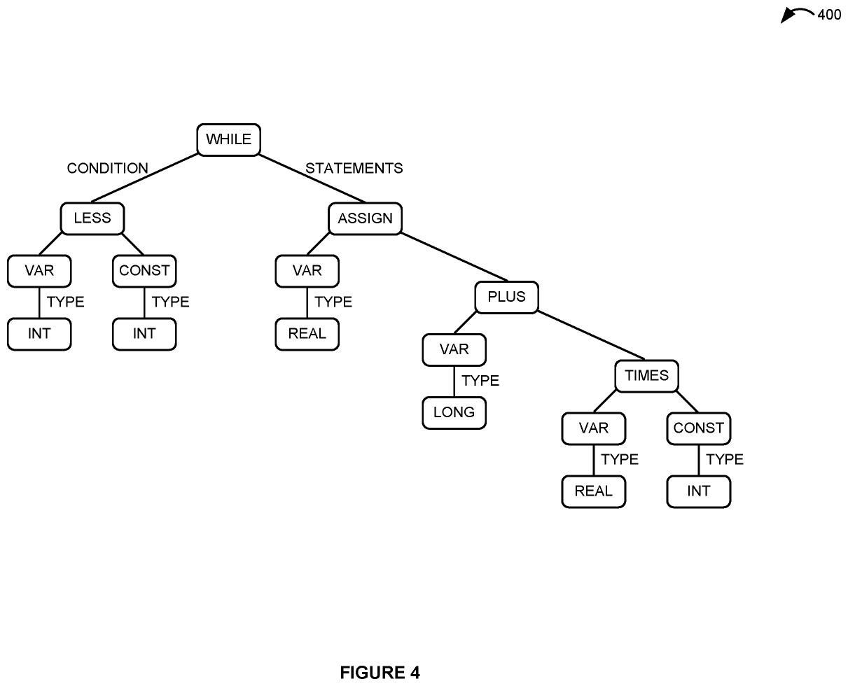

FIG. 3 is a block diagram that illustrates an example abstract syntax tree 300 generated for a web resource in an exemplary embodiment. Abstract syntax tree 300 provides an example of a normalized fingerprint generated for a web resource used to construct web applications. In this example, abstract syntax tree 300 represents a while loop appearing in the source code of the associated web resource. As shown in FIG. 3, the condition of the while loop appears in the left hand side of the tree, and the statements of the while loop are on the right hand side. The leaf nodes of abstract syntax tree 300 represent the data types of the constants and variables appearing in the while loop. As shown in the left hand side of abstract syntax tree 300, the condition for the while loop is when a variable of type real is less than a constant of type integer. While the condition is true, the statements for the while loop shown on the right hand side of tree 300 will assign a variable of type real equal to a variable of type integer summed with a variable of type real multiplied by a constant of type integer. In this manner, the syntactic structure and the operation of the while loop is expressed through abstract syntax tree 300. Another exemplary representation of a web resource expressed in an abstract syntax tree will now be discussed with respect to FIG. 4.

FIG. 4 is a block diagram that illustrates an example abstract syntax tree 400 generated for a web resource in an exemplary embodiment. Abstract syntax tree 400 provides an example of a normalized fingerprint generated for a web resource used to construct web applications. In this example, abstract syntax tree 400 represents a while loop appearing in the source code of the associated web resource. The syntactic structure of the while loop appearing in abstract syntax tree 400 is very similar to that of abstract syntax tree 300 of FIG. 3, except that the data types of several of the variables are different from the while loop shown in abstract syntax tree 300.

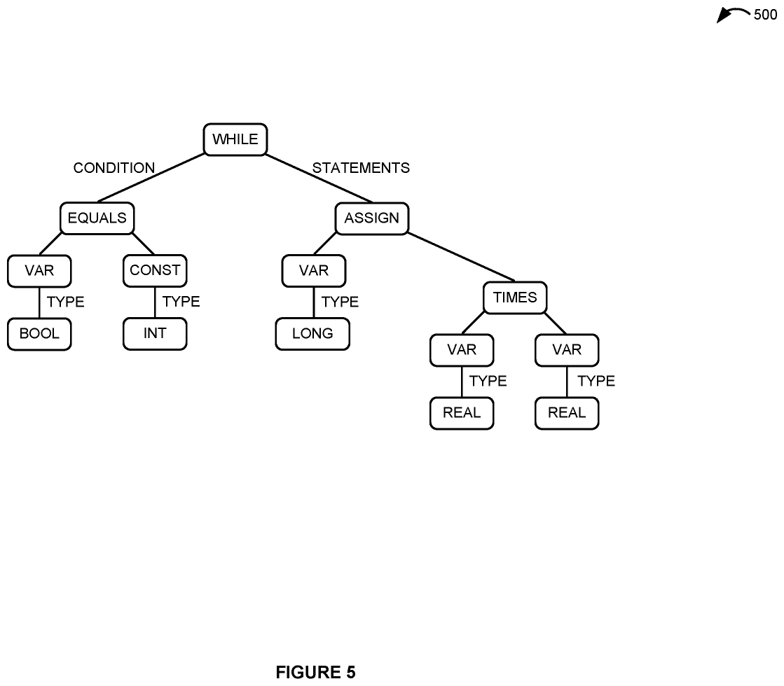

In particular, as shown in the left hand side of abstract syntax tree 400, the condition for the while loop is when a variable of type integer is less than a constant of type integer. Notably, the variable of type integer in the condition of the loop in tree 400 is different from the variable of type real used in the condition of the loop in tree 300. Moreover, while the condition is true, the statements for the while loop shown on the right hand side of abstract syntax tree 400 will assign a variable of type real equal to a variable of type long summed with a variable of type real multiplied by a constant of type integer. Again, the variable of type long appearing in tree 400 is different from the variable of type integer appearing at the same leaf node in tree 300. Therefore, although the syntactic structure of abstract syntax trees 300 and 400 are the same, the different data types appearing at two of the leaf nodes means that the trees 300 and 400 are not completely identical. Accordingly, upon comparing the fingerprint of the web resource represented by abstract syntax tree 300 to the fingerprint of the resource represented by tree 400, the variations between the trees 300 and 400 at the leaf nodes having different data types would be noticed when more exact fingerprinting techniques are employed, and a match may not be found between the two trees 300 and 400. However, when fuzzy fingerprinting techniques are used to compare trees 300 and 400, which allow for a higher tolerance of differences between mostly similar web objects, a match would still be found for trees 300 and 400, despite there being different data types on two of the leaf nodes. The degree of acceptable tolerance for minor differences when employing fuzzy fingerprinting techniques could be set based on the security needs of individual users. Another exemplary representation of a web resource expressed in an abstract syntax tree will now be discussed with respect to FIG. 5.

FIG. 5 is a block diagram that illustrates an example abstract syntax tree 500 generated for a web resource in an exemplary embodiment. Abstract syntax tree 500 provides an example of a normalized fingerprint generated for a web resource used to construct web applications. In this example, abstract syntax tree 500 represents a while loop appearing in the source code of the associated web resource. As shown in the left hand side of abstract syntax tree 500, the condition for the while loop is when a variable of type Boolean equals a constant of type integer. While the condition is true, the statements for the while loop shown on the right hand side of abstract syntax tree 500 will assign a variable of type long equal to a variable of type real multiplied by another variable of type real. In this example, both the syntactic structure and the variable data types of abstract syntax tree 500 differ greatly from the structure and data types of trees 300 and 400. Therefore, even fuzzy fingerprinting techniques would not find a match between tree 500 and either of trees 300 or 400. Accordingly, the system would have to search for other known web objects having fingerprints that more closely match that of abstract syntax tree 500 in order to return security risk factors or a reputation score for tree 500 from a matching web object and, failing that, would have to generate these factors for the unknown web object represented by tree 500 using the analysis techniques disclosed herein. A flow diagram that illustrates a data collection phase and an API call phase of the present security techniques will now be discussed with respect to FIG. 6.

FIG. 6 is a flow diagram that illustrates an operation of a communication system 600 in an exemplary embodiment. The operation of communication system 600 illustrates both a data collection phase and an API call phase, and describes how a repository of documents is crawled and its content analyzed for scripts and other objects to add to the body of resources on which the modeling algorithm is applied. The techniques described below with respect to FIG. 6 could be executed by the systems of communication system 100 such as computing system 101, and could be combined with operation 200 of FIG. 2 in some implementations.

Initially, in the data collection phase, a top websites list, web resources package list, and a JavaScript library package list are entered into a uniform resource locator (URL) database. The URLs in the URL database are processed to extract source data for web requests and renders for all of the top websites in the list, along with each package identified in the web resources package list and the JavaScript library package list, and any other source data that can be extracted from other CDNs. This aggregated source data is then analyzed and the results of the source analysis are stored in an analyses database.

The web resources package list and the JavaScript library package list are also provided to a package information database, along with public code repositories, such as CDNJS, npm, unpkg, jsDelivr, and other open source repositories. A vulnerabilities database is also populated with data from NVD, Snyk, and other vulnerability databases, along with outdated libraries databases such as RetireJS and others.

In the metadata creation phase for populating the Metabase, web crawling and scraping techniques are utilized to fetch and download all potential web objects, such as scripts, JavaScript libraries, fonts, style sheets, advertising content, and any other web content from an exhaustive list of CDNs. Each object is analyzed offline with an automated static and metadata analysis, which is supplemented with dynamic analysis attributes determined as and when the same libraries are encountered in periodic crawling of top websites. Each object obtained from the crawling and scraping is passed on to a system that performs various techniques for extracting the security attributes of the web objects. Object fingerprinting algorithms and the creation of abstract syntax trees are utilized in order to carry out the attribute extraction techniques. A ranking of each object is obtained by evaluating the frequency, consistency, and popularity across the most browsed websites in the world. In one example, this may be limited to the top one million websites based on user traffic. This ranking task is performed on a periodic basis to constantly keep up to date with the present web environment. Each of the above findings for an object are passed through different vulnerability databases, such as NVD, Snyk, and others, to determine which objects have potential security weaknesses, their severity, ease of exploit, and other vulnerabilities. Each of the above findings for an object are passed through different outdated libraries databases, such as RetireJS, to determine which objects rely on older versions of libraries that can have potential security weaknesses. More secure replacements of such objects are also made if necessary. Each JavaScript library is parsed to check for the presence of known dangerous JavaScript constructs, and appropriately noted for severity and ease of exploit of any such vulnerability. Each JavaScript library is also parsed to understand the behavior of any data collection, specifically any PII of users. The exact nature of the data collected is noted for each web object. A reputation score is then assigned to each web object based on analyzing the above findings. All the collected information is stored in a repository referred to as Metabase.

A system is provided so that end users can access the information in the Metabase repository using Metabase APIs. On a periodic basis, the information stored in the Metabase repository is updated by repeating the above methodology. The scope of the Metabase is also increased and updated based on incoming requests to Metabase.

In the metadata usage phase, the Metabase is queried using API calls to retrieve reputation scores and other API data for various web objects. Initially, web crawling and scraping techniques may be employed to fetch and download all web objects that are used in a web application, website, or document repository, and a list of resources used in constructing the web application is extracted. For each of the resources identified, the Metabase is then queried to retrieve the security attributes and reputation scores of each resource. A developer or security personnel may then be alerted about the risks that exceed a previously configured policy threshold, such as a reputation score below fifty from a possible range of zero to one hundred.

In examples where a website is under development, manual monitoring by a web developer or security personnel may be employed. Initially, the website to secure is crawled to extract a complete list of resources, including all JavaScript libraries used, all scripts present, web resources utilized, and the like. The security information for each of these objects is requested by performing API queries to Metabase. The Metabase repository retrieves the information regarding the objects and returns the requested information. In the unlikely event that the information for the object is not present, the system will generate the report in the same manner as described in the metadata creation phase, and deliver this information. The developer or security personnel will now have a comprehensive security posture of all the web resources that are being used under that website. Appropriate steps can be taken by these personnel regarding the information obtained, such as replacing an insecure web resource with a more secure alternative, upgrading from a deprecated library to a newer version of the same, and any other security actions. The developer or security personnel can set preferences in terms security score thresholds, deviations in behavior alerts, and other options that will be used when the website is ultimately deployed and live, and continuous monitoring is provided by the Metabase system.

When continuous monitoring is provided by the Metabase system, a website that this system is protecting is periodically scanned by the system and analyzed as described above. The results of the analysis of the system are generated for the developer or security personnel for abnormality and for security audit purposes of the webpage. In the scenario that the system detects a security score that is exceeding a threshold, which may be previously configured as discussed above, alerts will be sent to the appropriate personnel along with recommended suggestions. Upon receiving an alert, appropriate steps can be taken by these personnel regarding the information obtained, such as replacing an insecure web resource with a more secure alternative, upgrading from a deprecated library to a newer version of the same, and any other security actions. In this manner, security of the website is more robust, and the website is better protected against malicious attacks and vulnerabilities. A flow diagram that illustrates application usage for discovery of potential vulnerabilities will now be discussed with respect to FIG. 7.

FIG. 7 is a flow diagram that illustrates an operation of a communication system 700 in an exemplary embodiment. The operation of communication system 700 illustrates application usage for discovery of potential vulnerabilities through the operation of a web interface of the application. The techniques described below with respect to FIG. 7 could be executed by the systems of communication system 100 such as computing system 101, and could be combined with operation 200 of FIG. 2 in some implementations.

Initially, a website owner, developer, security personnel, or any other end user accesses a web interface of a web application that enables the discovery of potential vulnerabilities of a website. Using the web interface, the user supplies the webpage for analysis. Web crawling and scraping techniques are employed to fetch and download all web objects that are used in the webpage, including all JavaScript libraries used, all scripts present, web resources utilized, and the like, and a complete list of the resources used in constructing the webpage is extracted. For each of the resources identified in the list, security information for each of these resources is requested by performing API calls to Metabase to retrieve the security attributes and reputation scores of each resource. The Metabase repository retrieves the information regarding the resources and returns a list of resource attributes and security reputation scores of each resource, which are then provided to the user via the web interface. The user will now have a comprehensive security posture of all the web resources that are being used under that webpage. Appropriate steps can be taken by these personnel regarding the information obtained, such as replacing an insecure web resource with a more secure alternative, upgrading from a deprecated library to a newer version of the same, and any other security actions. In this manner, the webpage is afforded improved security and protection against malicious attacks and other vulnerabilities.

Now referring back to FIG. 1, computing system 101 may be representative of any computing apparatus, system, or systems on which the techniques disclosed herein or variations thereof may be suitably implemented. Computing system 101 comprises a processing system and communication transceiver. Computing system 101 may also include other components such as a router, server, data storage system, and power supply. Computing system 101 may reside in a single device or may be distributed across multiple devices. Computing system 101 be a discrete system or may be integrated within other systems, including other systems within communication system 100. Some examples of computing system 101 include desktop computers, server computers, cloud computing platforms, and virtual machines, as well as any other type of computing system, variation, or combination thereof. In some examples, computing system 101 could comprise a network switch, router, switching system, packet gateway, network gateway system, Internet access node, application server, database system, service node, firewall, or some other communication system, including combinations thereof.

Web resources 110 may be representative of any computing apparatus, system, or systems that may connect to another computing system over a communication network. Web resources 110 may comprise a data storage system and communication transceiver. Web resources 110 may also include other components such as a processing system, router, server, and power supply. Web resources 110 may reside in a single device or may be distributed across multiple devices. Web resources 110 may be a discrete system or may be integrated within other systems, including other systems within communication system 100. Some examples of web resources 110 include database systems, desktop computers, server computers, cloud computing platforms, and virtual machines, as well as any other type of computing system, variation, or combination thereof.

Communication network 120 could comprise multiple network elements such as routers, gateways, telecommunication switches, servers, processing systems, or other communication equipment and systems for providing communication and data services. In some examples, communication network 120 could comprise wireless communication nodes, telephony switches, Internet routers, network gateways, computer systems, communication links, or some other type of communication equipment, including combinations thereof. Communication network 120 may also comprise optical networks, packet networks, local area networks (LAN), metropolitan area networks (MAN), wide area networks (WAN), or other network topologies, equipment, or systems, including combinations thereof. Communication network 120 may be configured to communicate over wired or wireless communication links. Communication network 120 may be configured to use time-division multiplexing (TDM), Internet Protocol (IP), Ethernet, optical networking, wireless protocols, communication signaling, or some other communication format, including combinations thereof. In some examples, communication network 120 includes further access nodes and associated equipment for providing communication services to several computer systems across a large geographic region.

Communication links 111 and 112 use metal, air, space, optical fiber such as glass or plastic, or some other material as the transport medium, including combinations thereof. Communication links 111 and 112 could use various communication protocols, such as TDM, IP, Ethernet, telephony, optical networking, hybrid fiber coax (HFC), communication signaling, wireless protocols, or some other communication format, including combinations thereof. Communication links 111 and 112 could be direct links or may include intermediate networks, systems, or devices.

Turning now to FIG. 8, a block diagram is shown that illustrates computing system 800 in an exemplary implementation. Computing system 800 provides an example of computing system 101, or any computing system that may be used to execute security profile creation process 200 or variations thereof, although computing system 101 could use alternative configurations. Computing system 800 includes processing system 801, storage system 803, software 805, communication interface 807, and user interface 809. User interface 809 comprises display system 808. Software 805 includes application 806 which itself includes security profile creation process 200. Security profile creation process 200 may optionally be implemented separately from application 806, as indicated by the dashed line in FIG. 8.

Computing system 800 may be representative of any computing apparatus, system, or systems on which application 806 and security profile creation process 200 or variations thereof may be suitably implemented. Examples of computing system 800 include mobile computing devices, such as cell phones, tablet computers, laptop computers, notebook computers, and gaming devices, as well as any other type of mobile computing devices and any combination or variation thereof. Note that the features and functionality of computing system 800 may apply as well to desktop computers, server computers, and virtual machines, as well as any other type of computing system, variation, or combination thereof.

Computing system 800 includes processing system 801, storage system 803, software 805, communication interface 807, and user interface 809. Processing system 801 is operatively coupled with storage system 803, communication interface 807, and user interface 809. Processing system 801 loads and executes software 805 from storage system 803. When executed by computing system 800 in general, and processing system 801 in particular, software 805 directs computing system 800 to operate as described herein for security profile creation process 200 or variations thereof. Computing system 800 may optionally include additional devices, features, or functionality not discussed herein for purposes of brevity.

Referring still to FIG. 8, processing system 801 may comprise a microprocessor and other circuitry that retrieves and executes software 805 from storage system 803. Processing system 801 may be implemented within a single processing device but may also be distributed across multiple processing devices or sub-systems that cooperate in executing program instructions. Examples of processing system 801 include general purpose central processing units, application specific processors, and logic devices, as well as any other type of processing device, combinations, or variations thereof.

Storage system 803 may comprise any computer-readable storage media capable of storing software 805 and readable by processing system 801. Storage system 603 may include volatile and nonvolatile, removable and non-removable media implemented in any method or technology for storage of information, such as computer readable instructions, data structures, program modules, or other data. Storage system 603 may be implemented as a single storage device but may also be implemented across multiple storage devices or sub-systems co-located or distributed relative to each other. Storage system 603 may comprise additional elements, such as a controller, capable of communicating with processing system 601. Examples of storage media include random-access memory, read-only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the computer-readable storage media a propagated signal.

In operation, in conjunction with user interface 609, processing system 601 may load and execute portions of software 605, such as security profile creation process 200, to render a graphical user interface for application 606 for display by display system 808 of user interface 809. Software 805 may be implemented in program instructions and among other functions may, when executed by computing system 800 in general or processing system 801 in particular, direct computing system 800 or processing system 801 to receive a plurality of web resources used to construct web applications. Software 805 may further direct computing system 800 or processing system 801 to analyze the plurality of web resources to generate normalized fingerprints for each of the web resources. In addition, software 805 directs computing system 800 or processing system 801 to determine a plurality of security risk factors for each of the plurality of web resources based on the normalized fingerprints generated for each of the web resources. Finally, software 805 may direct computing system 800 or processing system 801 to generate a reputation score for each of the plurality of web resources based on the security risk factors determined for each of the web resources.

Software 805 may include additional processes, programs, or components, such as operating system software or other application software. Examples of operating systems include Windows®, iOS®, and Android®, as well as any other suitable operating system. Software 805 may also comprise firmware or some other form of machine-readable processing instructions executable by processing system 801.

In general, software 805 may, when loaded into processing system 801 and executed, transform computing system 800 overall from a general-purpose computing system into a special-purpose computing system customized to facilitate creation of security profiles for web application components as described herein for each implementation. For example, encoding software 805 on storage system 803 may transform the physical structure of storage system 803. The specific transformation of the physical structure may depend on various factors in different implementations of this description. Examples of such factors may include, but are not limited to the technology used to implement the storage media of storage system 803 and whether the computer-storage media are characterized as primary or secondary storage.

In some examples, if the computer-storage media are implemented as semiconductor-based memory, software 805 may transform the physical state of the semiconductor memory when the program is encoded therein. For example, software 805 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 800 is generally intended to represent a computing system with which software 805 is deployed and executed in order to implement application 806 and/or security profile creation process 200 (and variations thereof). However, computing system 800 may also represent any computing system on which software 805 may be staged and from where software 805 may be distributed, transported, downloaded, or otherwise provided to yet another computing system for deployment and execution, or yet additional distribution. For example, computing system 800 could be configured to deploy software 805 over the internet to one or more client computing systems for execution thereon, such as in a cloud-based deployment scenario.

Communication interface 807 may include communication connections and devices that allow for communication between computing system 800 and other computing systems (not shown) or services, over a communication network 811 or collection of networks. In some implementations, communication interface 807 receives dynamic data 821 over communication network 811. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 809 may include a voice input device, a touch input device for receiving a gesture from a user, a motion input device for detecting non-touch gestures and other motions by a user, and other comparable input devices and associated processing elements capable of receiving user input from a user. Output devices such as display system 808, speakers, haptic devices, and other types of output devices may also be included in user interface 809. The aforementioned user input devices are well known in the art and need not be discussed at length here. User interface 809 may also include associated user interface software executable by processing system 801 in support of the various user input and output devices discussed above. Separately or in conjunction with each other and other hardware and software elements, the user interface software and devices may provide a graphical user interface, a natural user interface, or any other kind of user interface. User interface 809 may be omitted in some examples.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a computing system to facilitate creation of security profiles for web application components, the method comprising:
receiving a plurality of web resources used to construct web applications;
analyzing the plurality of web resources to generate normalized fingerprints for each of the web resources;
determining a plurality of security risk factors for each of the plurality of web resources based on the normalized fingerprints generated for each of the web resources; and
generating a reputation score for each of the plurality of web resources based on the security risk factors determined for each of the web resources.

2. The method of claim 1 further comprising:
receiving an application programming interface (API) call that identifies a web object of a web application;
comparing the web object to the normalized fingerprints for each of the web resources to determine one of the web resources that matches the web object; and
returning the reputation score for the one of the web resources that matches the web object.

3. The method of claim 1 wherein analyzing the plurality of web resources to generate the normalized fingerprints for each of the web resources comprises analyzing syntactic structures of the plurality of web resources to generate the normalized fingerprints for each of the web resources.

4. The method of claim 1 wherein the normalized fingerprints generated for each of the web resources describe security attributes of each of the web resources.

5. The method of claim 1 wherein the normalized fingerprints generated for each of the web resources comprise abstract syntax trees.

6. The method of claim 1 wherein determining the plurality of security risk factors for each of the plurality of web resources comprises determining the plurality of security risk factors for each of the plurality of web resources based on prevalence of each of the web resources.

7. The method of claim 1 wherein generating the reputation score for each of the plurality of web resources based on the security risk factors comprises generating the reputation score for each of the web resources based on levels of information gain associated with each of the web resources.

8. One or more computer-readable storage media having program instructions stored thereon to facilitate creation of security profiles for web application components, wherein the program instructions, when executed by a computing system, direct the computing system to at least:
receive a plurality of web resources used to construct web applications;
analyze the plurality of web resources to generate normalized fingerprints for each of the web resources;
determine a plurality of security risk factors for each of the plurality of web resources based on the normalized fingerprints generated for each of the web resources; and
generate a reputation score for each of the plurality of web resources based on the security risk factors determined for each of the web resources.

9. The one or more computer-readable storage media of claim 8 wherein the program instructions further direct the computing system to:
receive an application programming interface (API) call that identifies a web object of a web application;
compare the web object to the normalized fingerprints for each of the web resources to determine one of the web resources that matches the web object; and
return the reputation score for the one of the web resources that matches the web object.

10. The one or more computer-readable storage media of claim 8 wherein the program instructions direct the computing system to analyze the plurality of web resources to generate the normalized fingerprints for each of the web resources by directing the computing system to analyze syntactic structures of the plurality of web resources to generate the normalized fingerprints for each of the web resources.

11. The one or more computer-readable storage media of claim 8 wherein the normalized fingerprints generated for each of the web resources describe security attributes of each of the web resources.

12. The one or more computer-readable storage media of claim 8 wherein the normalized fingerprints generated for each of the web resources comprise abstract syntax trees.

13. The one or more computer-readable storage media of claim 8 wherein the program instructions direct the computing system to determine the plurality of security risk factors for each of the plurality of web resources by directing the computing system to determine the plurality of security risk factors for each of the plurality of web resources based on prevalence of each of the web resources.

14. The one or more computer-readable storage media of claim 8 wherein the program instructions direct the computing system to generate the reputation score for each of the plurality of web resources based on the security risk factors by directing the computing system to generate the reputation score for each of the web resources based on levels of information gain associated with each of the web resources.

15. An apparatus comprising:
one or more computer-readable storage media; and
program instructions stored on the one or more computer-readable storage media that, when executed by a processing system, direct the processing system to at least:
receive a plurality of web resources used to construct web applications;
analyze the plurality of web resources to generate normalized fingerprints for each of the web resources;
determine a plurality of security risk factors for each of the plurality of web resources based on the normalized fingerprints generated for each of the web resources; and
generate a reputation score for each of the plurality of web resources based on the security risk factors determined for each of the web resources.

16. The apparatus of claim 15 wherein the program instructions further direct the processing system to:
receive an application programming interface (API) call that identifies a web object of a web application;
compare the web object to the normalized fingerprints for each of the web resources to determine one of the web resources that matches the web object; and
return the reputation score for the one of the web resources that matches the web object.

17. The apparatus of claim 15 wherein the program instructions direct the processing system to analyze the plurality of web resources to generate the normalized fingerprints for each of the web resources by directing the processing system to analyze syntactic structures of the plurality of web resources to generate the normalized fingerprints for each of the web resources.

18. The apparatus of claim 15 wherein the normalized fingerprints generated for each of the web resources describe security attributes of each of the web resources.

19. The apparatus of claim 15 wherein the normalized fingerprints generated for each of the web resources comprise abstract syntax trees.

20. The apparatus of claim 15 wherein the program instructions direct the processing system to determine the plurality of security risk factors for each of the plurality of web resources by directing the processing system to determine the plurality of security risk factors for each of the plurality of web resources based on prevalence of each of the web resources.
